(19) United States
(12) Patent Application Publication
(10) Pub. No.: US 2014/0208133 A1
(43) Pub. Date: Jul. 24, 2014

(54) SYSTEMS AND METHODS FOR OUT-OF-BAND MANAGEMENT OF AN INFORMATION HANDLING SYSTEM

(71) Applicant: DELL PRODUCTS L.P., Round Rock, TX (US)

(72) Inventors: Janardan Rajagopal Pradeep Gopal, Round Rock, TX (US); Christopher Joseph Graham, Austin, TX (US)

(73) Assignee: DELL PRODUCTS L.P., Round Rock, TX (US)

(21) Appl. No.: 13/748,340

(22) Filed: Jan. 23, 2013

(51) Int. Cl. G06F 1/26

(52) U.S. Cl. CPC G06F 1/26
USPC 713/310

(57) ABSTRACT

In accordance with embodiments of the present disclosure, an access controller of an information handling system may be configured to receive a management operation from a management server communicatively coupled to an out-of-band network interface of the information handling system. The access controller may further be configured to, in response to receipt of the management operation and in concert with a basic input/output system of the information handling system, cause the information handling system to enter a power state in which a computer-readable medium associated with the information handling system is powered on. The access controller may also be configured to, in concert with the basic input/output system, transfer data associated with the management operation from the management server to the computer-readable medium.

### TECHNICAL FIELD

The present disclosure relates in general to information handling systems, and more particularly to out-of-band management of an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Client management of an information handling system, in which an information handling system known as a client is managed by another information handling system communicatively coupled to the client via a network and known as a management server, is becoming increasingly commonplace. Traditionally, client management is conducted in one of two ways. The first is “in-band” management, in which the management server manages the client while the client is powered on, fully booted, and executing an operating system. The second is “out-of-band” management, in which the management server undertakes remote monitoring and management regardless of whether the client information handling system is powered on and/or has an operating system executing or even installed thereon. To perform out-of-band management, traditional approaches require that special hardware known as a service processor be installed within the client information handling system. The service processor requires a source of electrical power (e.g., a battery or a power source engaged with a power outlet), but may communicate with the management server via a management channel physically isolated from an in-band communication channel present when an operating system is executing on the client information handling system. Thus, for example, if a failure occurs in the client information handling system that prevents an administrator from remotely accessing the client information handling system via its traditional network interface (e.g., operating system failure, power failure, etc.), the administrator may still be able to monitor and/or manage the client information handling system (e.g., to diagnose problems that may have caused failure) via the service processor. A service processor may allow an administrator to remotely manage one or more parameters associated with operation of the client information handling system (e.g., power usage, processor allocation, memory allocation, security privileges, etc.) and/or communicate updates and patches to the client information handling system (e.g., Basic Input/Output System updates, driver updates, etc.). Such a service processor may include or may be an integral part of an access controller, baseboard management controller (BMC), Dell Remote Access Controller (DRAC) or an Integrated Dell Remote Access Controller (iDRAC).

Despite the utility of out-of-band management, out-of-band manageability is not traditionally utilized in end-user computing. In comparison to out-of-band server management solutions, end-user information handling systems rely on a limited set of resources to support existing features of out-of-band management. In addition, out-of-band management is fairly standardized on the network side (e.g., client information handling system to management console), but not presently standardized within an information handling system (e.g., service processor to basic input/output system).

However, out-of-band management may offer significant advantages in platform serviceability and control that for which consumers of end-user information handling systems may want to take advantage. For example, remote remediation via out-of-band management is an alternative to costly desk-side visits or replacement of components.

### SUMMARY

In accordance with the teachings of the present disclosure, the disadvantages and problems associated with client management of an information handling system have been reduced or eliminated.

In accordance with embodiments of the present disclosure, an information handling system may include a processor, a basic input/output system communicatively coupled to the processor and comprising a program of instructions executable on the processor, an in-band network interface communicatively coupled to the processor, and an access controller communicatively coupled to the processor comprising an out-of-band network interface configured to communicate via a communication channel physically isolated from the in-band network interface. The access controller may be configured to receive a management operation from a management server communicatively coupled to the out-of-band network interface. The access controller may further be configured to, in response to receipt of the management operation and in concert with the basic input/output system, cause the information handling system to enter a power state in which a computer-readable medium associated with the information handling system is powered on. The access controller may also be configured to, in concert with the basic input/output system, transfer data associated with the management operation from the management server to the computer-readable medium.

In accordance with these and other embodiments of the present disclosure, a method may include receiving, at an access controller integral to an information handling system and having an out-of-band network interface configured to communicate via a communication channel physically isolated from an in-band network interface integral to the information handling system, a management operation from a management server communicatively coupled to the out-of-band network interface. The method may also include in response to receipt of the management operation and in concert with a basic input/output system integral to the information handling system, causing the information handling system to enter a power state in which a computer-readable medium associated with the information handling system is powered on. The method may also include in concert with the basic input/output system, transferring data associated with the management operation from the management server to the computer-readable medium.

In accordance with these and other embodiments of the present disclosure, an article of manufacture may include a computer readable medium and computer-executable instructions carried on the computer readable medium. The instructions may be readable by a processor, the instructions, when read and executed, for causing the processor to: (i) receive, at an access controller integral to an information handling system and having an out-of-band network interface configured to communicate via a communication channel physically isolated from an in-band network interface integral to the information handling system, a management operation from a management server communicatively coupled to the out-of-band network interface; (ii) in response to receipt of the management operation and in concert with a basic input/output system integral to the information handling system, cause the information handling system to enter a power state in which a computer-readable medium associated with the information handling system is powered on; and (iii) in concert with the basic input/output system, transfer data associated with the management operation from the management server to the computer-readable medium.

Technical advantages of the present disclosure will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for management of an information handling system, in accordance with certain embodiments of the present disclosure; and

FIG. 2 illustrates a flow chart of an example method for client management of an information handling system, in accordance with certain embodiments of the present disclosure.

### DETAILED DESCRIPTION

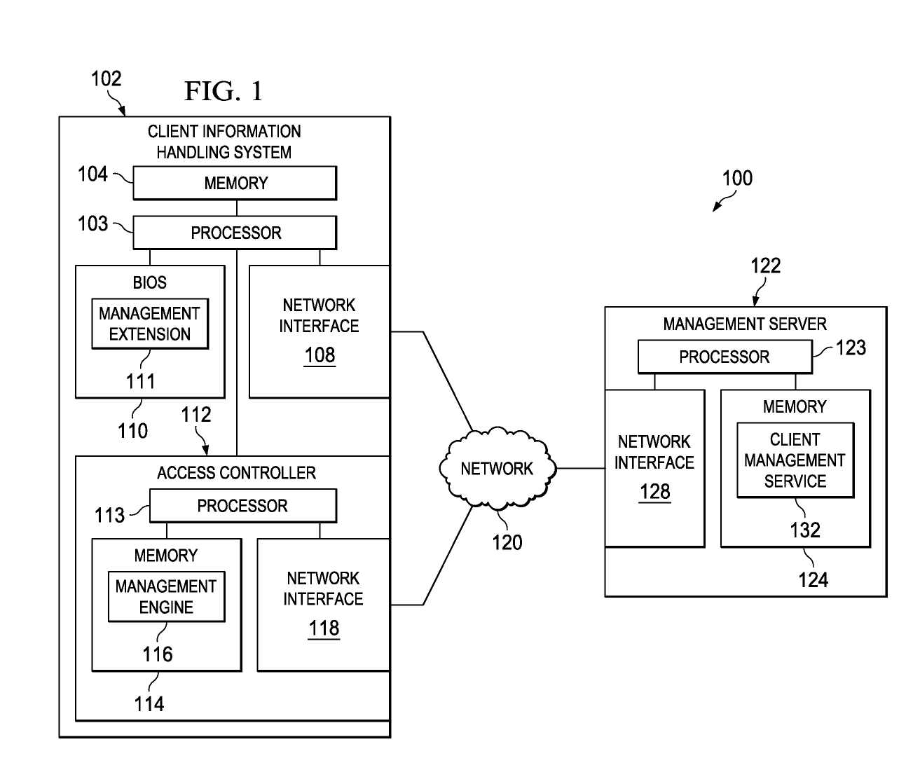

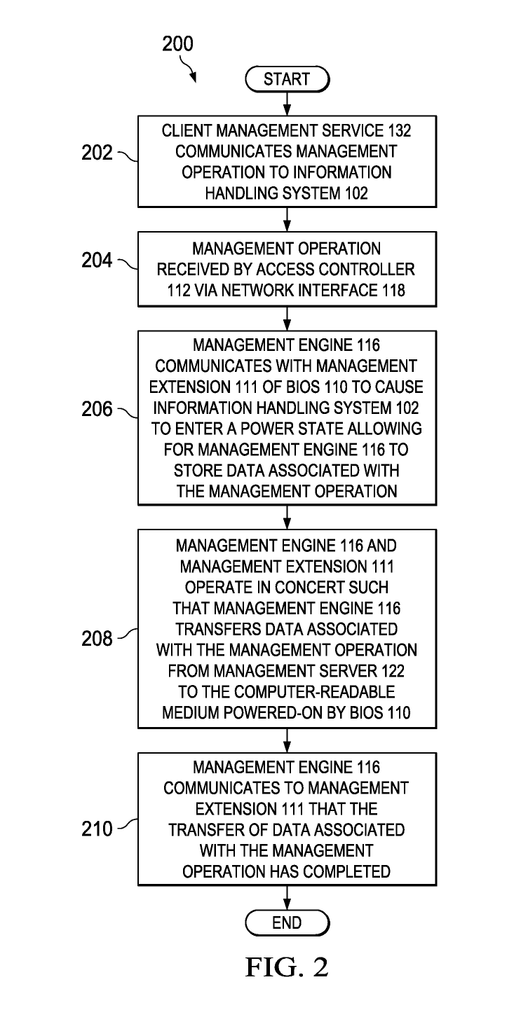

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more busses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, busses, memories, I/O devices and/or interfaces, storage resources, network interfaces, motherboards, and/or any other components and/or elements of an information handling system.

For the purposes of this disclosure, a digital asset may broadly refer to any software application, deliverable or performable service (e.g., one or more commands or instructions), music, video, software activation key, personalization instructions, files, management data, configuration data, or other digital media that is digitally deliverable either wholly or partially.

FIG. 1 illustrates a block diagram of an example system 100 for management of a client information handling system 102, in accordance with certain embodiments of the present disclosure. As shown in FIG. 1, system 100 may include a client information handling system 102 and a management server 122, and a network 120 communicatively coupling management server 122 to client information handling system 102.

In some embodiments, client information handling system 102 may be a personal computer. In particular embodiments, client information handling system 102 may be a portable information handling system (e.g., a laptop, notebook, tablet, handheld, smart phone, personal digital assistant, etc.). As depicted in FIG. 1, client information handling system 102 may include a processor 103, a memory 104 communicatively coupled to processor 103, a network interface 108 communicatively coupled to processor 103, and a basic input/output system (BIOS) 110 communicatively coupled to processor 103.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, BIOS 110, and/or another component of client information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to client information handling system 102 is turned off.

Network interface 108 may comprise any suitable system, apparatus, or device operable to serve as an interface between client information handling system 102 and management server 122 and/or other information handling systems. Network interface 108 may enable client information handling system 102 to communicate using any suitable transmission protocol and/or standard, including without limitation, all transmission protocols and/or standards enumerated below with respect to the discussion of network 120. In these and other embodiments, network interface 108 may comprise a network interface card, or “NIC.”

BIOS 110 may be communicatively coupled to processor 103 and may include any system, device, or apparatus configured to identify, test, and/or initialize information handling resources of client information handling system 102. “BIOS” may broadly refer to any system, device, or apparatus configured to perform such functionality, including without limitation, a Unified Extensible Firmware Interface (UEFI). In some embodiments, BIOS 110 may be implemented as a program of instructions that may be read by and executed on processor 103 to carry out the functionality of BIOS 110. In these and other embodiments, BIOS 110 may comprise boot firmware configured to be the first code executed by processor 103 when client information handling system 102 is booted and/or powered on. As part of its initialization functionality, BIOS code may be configured to set components of client information handling system 102 into a known state, so that one or more applications (e.g., an operating system or other application programs) stored on compatible media (e.g., memory 104) may be executed by processor 103 and given control of client information handling system 102.

As shown in FIG. 1, BIOS 110 may include management extension 111. As described in greater detail elsewhere in this disclosure, management extension 111 may include any system, device, or apparatus configured to, during execution of BIOS 110, operate in concert with management engine 116 of access controller 112 to carry out out-of-band management operations communicated from management server 122, including without limitation, updates to firmware of client information handling system 102 communicated from management server 122. In some embodiments, management extension 111 may be implemented as a program of instructions that may be read by and executed on processor 103 to carry out the functionality of management extension 111. In embodiments in which BIOS 110 comprises a UEFI, management extension 111 may comprise a UEFI extension.

Access controller 112 may be configured to provide out-of-band management facilities for management of information handling system 102. Such management may be made by access controller 112 even if information handling system 102 is powered off or powered to a standby state. Access controller 112 may include a processor 113, memory 114, and an out-of-band network interface 118 separate from and physically isolated from in-band network interface 108. In certain embodiments, access controller 112 may include or may be an integral part of a BMC, DRAC, or an iDRAC.

Processor 113 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions and/or process data stored in memory 114 and/or another component of client information handling system 102 or access controller 112.

Memory 114 may be communicatively coupled to processor 113 and may include any system, device, or apparatus configured to retain program instructions and/or data for a period of time (e.g., computer-readable media). Memory 114 may include RAM, EEPROM, a PCMCIA card, flash memory, magnetic storage, opto-magnetic storage, or any suitable selection and/or array of volatile or non-volatile memory that retains data after power to access controller 112 is turned off.

As shown in FIG. 1, memory 114 may include management engine 116. As described in greater detail elsewhere in this disclosure, management engine 116 may include any system, device, or apparatus configured to, during execution of BIOS 110, operate in concert with management extension 111 of BIOS 110 to carry out out-of-band management operations communicated from management server 122, including without limitation, updates to firmware of client information handling system 102 communicated from management server 122. In some embodiments, management engine 116 may be implemented as a program of instructions that may be read by and executed on processor 113 or processor 103 to carry out the functionality of management engine 116.

Network interface 118 may comprise any suitable system, apparatus, or device operable to serve as an interface between access controller 112 and management server 122 and/or other information handling systems. Network interface 118 may enable access controller 112 to communicate using any suitable transmission protocol and/or standard, including without limitation, all transmission protocols and/or standards enumerated below with respect to the discussion of network 120. In these and other embodiments, network interface 118 may comprise a network interface card, or “NIC.”

In addition to processor 103, memory 104, network interface 108, BIOS 110, and access controller 112, client information handling system 102 may include one or more other information handling resources.

Network 120 may be a network and/or fabric configured to couple management server 122 and information handling system 120 to each other and/or one or more other information handling systems. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

In some embodiments, management server 122 may be a server. In other embodiments, management server 122 may be a personal computer (e.g., a desktop computer or a portable computer). As depicted in FIG. 1, management server 122 may include a processor 123, a memory 124 communicatively coupled to processor 123, and a network interface 128 communicatively coupled to processor 123.

Processor 123 may include any system, device, or apparatus configured to interpret and/or execute program instructions and/or process data, and may include, without limitation a microprocessor, microcontroller, DSP, ASIC, or any other digital or analog circuitry configured to interpret and/or execute program instructions and/or process data. In some embodiments, processor 123 may interpret and/or execute program instructions and/or process data stored in memory 124 and/or another component of management server 122.

Memory 124 may be communicatively coupled to processor 123 and may include any system, device, or apparatus configured to retain program instructions and/or data for a period of time (e.g., computer-readable media). Memory 124 may include RAM, EEPROM, a PCMCIA card, flash memory, magnetic storage, opto-magnetic storage, or any suitable selection and/or array of volatile or non-volatile memory that retains data after power to management server 122 is turned off.

As shown in FIG. 1, memory 124 may have stored thereon client management service 132. Client management service 132 may include any system, device, or apparatus configured to, as described in greater detail elsewhere in this disclosure, manage client information handling system 102 by communicating management operations to client information handling system 102 via network 120. In some embodiments, client management service 132 may be implemented as a program of instructions that may be read by and executed on processor 123 to carry out the functionality of client management service 132.

Network interface 128 may comprise any suitable system, apparatus, or device operable to serve as an interface between management server 122 and network 120. Network interface 128 may enable management server 122 to communicate using any suitable transmission protocol and/or standard, including any of the protocols and/or standards described above with respect to network 120. In these and other embodiments, network interface 128 may comprise a NIC.

In addition to processor 123, memory 124, and network interface 128, management server 122 may include one or more other information handling resources.

In operation, client management service 132 may communicate a management operation, for example a firmware update, to information handling system 102 via network 120 using any suitable management protocol (e.g., Simple Network Management Protocol). Such management operation may be received by access controller 112 via network interface 118. In response to receipt of the management operation, management engine 116 may communicate with management extension 111 of BIOS 110 to cause information handling system 102 to enter a power state allowing for management engine 116 to store data associated with the management operation. For example, BIOS 110 may power on memory 104 to permit storage of such data. In addition or alternatively, BIOS 110 may power on another information handling resource (e.g., an external flash memory), to permit storage of such data. In any event, management engine 116 and management extension 111 may operate in concert such that management engine 116 may transfer data associated with the management operation from management server 122 to the computer-readable medium powered-on by BIOS 110. After the transfer is complete, management engine 116 may communicate to management extension 111 that the transfer of data associated with the management operation has completed. On a subsequent power on or boot of client information handling system 102, BIOS 110 may determine that data associated with the management operation (e.g., a BIOS firmware update or firmware update for another information handling resource) is present and install such data to client information handling system 102.

FIG. 2 illustrates a flow chart of an example method 200 for client management of client information handling system 102, in accordance with certain embodiments of the present disclosure. According to one embodiment, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, client management service 132 may communicate a management operation, for example a firmware update, to information handling system 102 via network 120 using any suitable management protocol (e.g., Simple Network Management Protocol). At step 204, such management operation may be received by access controller 112 via network interface 118. At step 206, in response to receipt of the management operation, management engine 116 may communicate with management extension 111 of BIOS 110 to cause information handling system 102 to enter a power state allowing for management engine 116 to store data associated with the management operation. For example, BIOS 110 may power on memory 104 to permit storage of such data. In addition or alternatively, BIOS 110 may power on another information handling resource (e.g., an external flash memory) to permit storage of such data.

At step 208, management engine 116 and management extension 111 may operate in concert such that management engine 116 may transfer data associated with the management operation from management server 122 to the computer-readable medium powered-on by BIOS 110. At step 210, after the transfer is complete, management engine 116 may communicate to management extension 111 that the transfer of data associated with the management operation has completed. Thus, on a subsequent power on or boot of client information handling system 102, BIOS 110 may determine that data associated with the management operation (e.g., a BIOS firmware update or firmware update for another information handling resource) is present and install such data to client information handling system 102.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using system 100 or any other system operable to implement method 200. In certain embodiments, method 200 may be implemented partially or fully in software and/or firmware embodied in computer-readable media.

In addition to or in lieu of the various functionality described above, in some embodiments, management engine 116 or another information handling resource of client information handling system 102 may communicate information to management server 122 or another information handling system (e.g., a management agent communicatively coupled to information handling system 102 via in-band network interface 108) regarding the management operation. For example, such information may include status information relating to completion of the management operation (e.g., in the case of a firmware update, the percentage of completion of the transfer of firmware update or whether management extension 111 has yet performed the update.

In addition to or in lieu of the various functionality described above, in some embodiments, management server 122 or another information handling system communicatively coupled to client information handling system 102 may be configured to interrogate management engine 116, management extension 111, or another information handling resource of client information handling system 102 regarding the management operation (e.g., in the case of a firmware update for, interrogate regarding completeness of the firmware update, validity of the firmware, or whether the firmware has been subject to tampering or corruption.

Although the present disclosure has been described in detail, it should be understood that various changes, substitutions, and alterations can be made hereto without departing from the spirit and the scope of the disclosure as defined by the appended claims.

What is claimed is:

1. An information handling system comprising:
a processor;
a basic input/output system communicatively coupled to the processor and comprising a program of instructions executable on the processor;
an in-band network interface communicatively coupled to the processor; and
an access controller communicatively coupled to the processor comprising an out-of-band network interface configured to communicate via a communication channel physically isolated from the in-band network interface, the access controller configured to:
receive a management operation from a management server communicatively coupled to the out-of-band network interface;
in response to receipt of the management operation and in concert with the basic input/output system, cause the information handling system to enter a power state in which a computer-readable medium associated with the information handling system is powered on; and
in concert with the basic input/output system, transfer data associated with the management operation from the management server to the computer-readable medium.

2. The information handling system of claim 1, the basic input/output system configured to, on a boot subsequent to transfer of the data associated with the management operation, install the data to the information handling system.

3. The information handling system of claim 1, wherein the data associated with the management operation comprises a firmware update.

4. The information handling system of claim 1, wherein the computer-readable medium is a memory integral to the information handling system.

5. The information handling system of claim 1, wherein the computer-readable medium is an external storage resource.

6. A method comprising:
receiving, at an access controller integral to an information handling system and having an out-of-band network interface configured to communicate via a communication channel physically isolated from an in-band network interface integral to the information handling system, a management operation from a management server communicatively coupled to the out-of-band network interface;
in response to receipt of the management operation and in concert with a basic input/output system integral to the information handling system, causing the information handling system to enter a power state in which a computer-readable medium associated with the information handling system is powered on; and
in concert with the basic input/output system, transferring data associated with the management operation from the management server to the computer-readable medium.

7. The method of claim 6, further comprising, installing, by the basic input/output system on a boot subsequent to transfer of the data associated with the management operation, the data to the information handling system.

8. The method of claim 6, wherein the data associated with the management operation comprises a firmware update.

9. The method of claim 6, wherein the computer-readable medium is a memory integral to the information handling system.

10. The method of claim 6, wherein the computer-readable medium is an external storage resource.

11. An article of manufacture comprising:
a computer readable medium; and
computer-executable instructions carried on the computer readable medium, the instructions readable by a processor, the instructions, when read and executed, for causing the processor to:
receive, at an access controller integral to an information handling system and having an out-of-band network interface configured to communicate via a communication channel physically isolated from an in-band network interface integral to the information handling system, a management operation from a management server communicatively coupled to the out-of-band network interface;
in response to receipt of the management operation and in concert with a basic input/output system integral to the information handling system, cause the information handling system to enter a power state in which a computer-readable medium associated with the information handling system is powered on; and
in concert with the basic input/output system, transfer data associated with the management operation from the management server to the computer-readable medium.

12. The article of claim 11, further comprising the instructions for further causing the basic input/output system on a boot subsequent to transfer of the data associated with the management operation, to install the data to the information handling system.

13. The article of claim 11, wherein the data associated with the management operation comprises a firmware update.

14. The article of claim 11, wherein the computer-readable medium is a memory integral to the information handling system.

15. The article of claim 11, wherein the computer-readable medium is an external storage resource.
